(19) United States
(12) Patent Application Publication
(10) Pub. No.: US 2023/0361433 A1
(43) Pub. Date: Nov. 9, 2023

(54) Apparatus For Assembling Battery Cells Or Battery Modules

(71) Applicant: Comau S.p.A., Grugliasco (torino) (IT)

(72) Inventors: Valeria Serpi, Grugliasco (Torino) (IT); Marco Spagnoli, Grugliasco (Torino) (IT); Giovanni Di Stefano, Grugliasco (Torino) (IT); Beatrice Demarie, Grugliasco (Torino) (IT); Salvatore Macaluso, Grugliasco (Torino) (IT); Constantino Pischedda, Grugliasco (torino) (IT)

(21) Appl. No.: 17/912,320

(22) PCT Filed: Mar. 17, 2021
(86) PCT No.: PCT/IB2021/052226

§ 371 Date: Sep. 16, 2022

(30) Foreign Application Priority Data
Mar. 20, 2020 (IT) 102020000006016

(51) Int. Cl. H01M 50/516; B23K 26/21; H04N 23/90; H04N 23/695; H04N 23/23

(52) U.S. Cl. CPC H01M 50/516; B23K 26/21; H04N 23/90; H04N 23/695; H04N 23/23

(57) ABSTRACT

An apparatus for assembling battery cells or battery modules together each having electrical terminals that must be subjected to a welding operation. The apparatus includes a tool for engaging and holding the battery cells or the battery modules to be welded, which can be moved along at least two axes to carry and maintain one or more battery cells or battery modules in a configuration r position suitable for welding the electrical terminals to at least one of respective electrical connecting elements or welding said electrical terminals to each other. The apparatus also includes a welding head carried by said tool and arranged to perform welding operations on the electrical terminals to be welded.

### CROSS-REFERENCE TO RELATED APPLICATION(S)

This application is filed pursuant to 35 U.S.C. § 371 claiming priority benefit to PCT/IB2021/052226 filed Mar. 17, 2021, which claims priority to Italian Patent Application No. 102020000006016 filed Mar. 20, 2020, the contents of both applications are incorporated herein by reference in their entirety for all purposes.

### TECHNICAL FIELD

The present invention refers, in general, to apparatuses and methods for assembling electric batteries.

The invention relates—in particular—to an apparatus for assembling together battery cells or battery modules, wherein said battery cells or battery modules include electrical terminals that must be subjected to a welding operation.

### BACKGROUND

An apparatus of the type indicated above is known, for example, in the document U.S. Pat. No. 8,460,817 B2. However, the solution described in this document is not fully satisfactory from various points of view, in particular, in terms of constructive simplicity and in terms of speed, as well as efficiency, of the assembly operations, for assembling battery cells or battery modules together.

Additional aspects to consider are the adaptability of the apparatus to different types of battery cells, and the simplicity of the operations required for placement in a production site and commissioning of the apparatus.

### SUMMARY

The object of the invention is to produce an apparatus of the type indicated above, which is constructively simple, functional, and with high flexibility of use.

Another object of the invention is to produce an apparatus of the type indicated above that can be easily and quickly adapted to different applications, and in particular to different battery cell configurations.

Another object of the invention is that of producing a welding apparatus of the type indicated above that ensures excellent welding quality, and the simple and reliable control of a step preliminary to the welding, wherein the elements to be welded are brought into a configuration suitable for welding.

Another object of the invention is to produce an apparatus of the type indicated above, which has compact dimensions, and which has simple and rapid commissioning/installation procedures, so as to be particularly suitable for being transported and made operational in different sites of production.

Yet another object of the invention is to produce an apparatus of the type indicated above that allows monitoring the quality of a weld bead made with the apparatus.

According to one or more embodiments, one or more of the preceding objects are achieved through an apparatus having the distinctive characteristics specifically set forth in the following claims.

In particular, the invention relates to an apparatus for assembling battery cells or battery modules together, wherein said battery cells or battery modules comprise electrical terminals that must be subjected to a welding operation, said apparatus including:
a tool for engaging and holding the elements (i.e., the battery cells or the battery modules) to be welded, which can be moved along at least two axes to carry and maintain one or more battery cells or battery modules in a configuration and/or position suitable for carrying out the welding of the electrical terminals of said battery cells or modules to respective electrical connecting elements and/or for welding said electrical terminals together,
a welding head carried on said tool and arranged to perform welding operations on the elements to be welded,
wherein said tool and said welding head are controlled in such a way that the tool carries said battery cells or battery modules into said configuration and/or position suitable for performing the welding, and maintains said battery cells or modules in said configuration and/or position during welding, if necessary by applying pressure on the elements to be welded,
said tool being configured in such a way that the welding head can operate to perform the welding while the tool maintains said battery cells or battery modules in said configuration and/or position suitable for carrying out the welding.

According to a preferred characteristic of the invention, the welding head carried on said tool is configured to carry out the welding while remaining in a remote position with respect to the elements to be welded.

In one or more embodiments, the welding head is configured to move integrally with said tool along said at least two axes, and is configured to move and/or oscillate along at least a third axis.

In one or more embodiments, the tool for engaging and holding the elements to be welded is a tool assembly also capable of bending, configured to simultaneously bend one or more elements, prior to welding.

In one or more embodiments, the apparatus includes a system for automatically controlling the quality of the welding carried out by means of the welding head, implemented by means of at least one thermal camera configured to control the quality of a weld bead in a welding area.

In one or more embodiments, the system for automatically controlling the welding quality includes a first and a second thermal camera controlled so that one of said first and second thermal cameras is always aligned with respect to a position wherein the head is located for carrying out welding, and the other of said first and second thermal camera is still arranged in a position further back, along a respective auxiliary guiding bar, aligned with a previous position of the welding head, in such a way that the thermal camera in the rearmost position controls the cooling step of a weld bead, after the welding has been performed.

In one or more embodiments, the apparatus is carried—as a whole—on a single, palletizable, equipped platform.

In one or more embodiments, the apparatus comprises service systems for the electrical and/or fluid supply to said apparatus, and quick-coupling devices of the “plug-in” type, for coupling with external systems of electrical power and/or fluid supply.

The embodiments also regard a related method for assembling battery cells or battery modules together, wherein said battery cells or battery modules comprise electrical terminals, which must be subjected to a welding operation, said method comprising the following steps:
controlling said tool for engaging and holding the elements to be welded, along said at least two axes in such a way as to carry and maintain one or more battery cells or battery modules in a configuration and/or position suitable for carrying out the welding of the electrical terminals of said battery cells or modules to respective electrical connecting elements and/or for welding said electrical terminals together,
welding said elements by means of said welding head carried by said tool.

The embodiments also relate to a relative method for controlling the quality of the welding carried out by means of the aforesaid apparatus, as indicated in the attached claims.

Thanks to the aforesaid characteristics, the apparatus according to the invention presents a series of advantages. In particular:
the apparatus according to the invention ensures a high welding quality, and the simple and reliable control of a step preliminary to the welding, wherein the elements to be welded are brought into a configuration and/or position suitable for carrying out the welding;
the apparatus according to the invention allows simultaneously bending of a row of terminals of a plurality of side-by-side cells, prior to the welding of the terminals;
the apparatus according to the invention is compact in size and has a simple and quick commissioning/installation step, and is also easily transportable to different production sites;
the apparatus according to the invention is easily and quickly adaptable to different applications, thus presenting a high flexibility of use; and
the apparatus according to the invention allows monitoring the quality of a weld bead made with a welding head that is part of the apparatus, also controlling the cooling step of each weld bead, without thereby inducing delays in the cycle time of the apparatus.

### BRIEF DESCRIPTION OF THE DRAWINGS

Further characteristics and advantages of the invention will become apparent from the description that follows with reference to the attached drawings, provided purely by way of non-limiting example, wherein:

FIGS. 1, 2 are alternate perspective views of an apparatus for assembling battery cells or battery modules together, according to a preferred embodiment of the invention;

FIG. 3 is a schematic cross-sectional view of the apparatus illustrated in the previous Figures;

FIG. 4 is a schematic perspective view on an enlarged scale of a battery pack to be assembled by means of the apparatus according to the invention;

FIGS. 5A-5C are schematic cross-sectional views that illustrate some steps of the method that can be implemented with the apparatus according to the invention;

FIGS. 6-9 are schematic plan views that illustrate additional steps of the method that can be implemented with the apparatus according to the invention, and

FIG. 10 is a perspective view of an apparatus according to an additional embodiment of the invention.

### DETAILED DESCRIPTION

In the following description various specific details are illustrated aimed at a thorough understanding of examples of one or more embodiments. The embodiments can be implemented without one or more of the specific details, or with other methods, components, materials, etc. In other cases, known structures, materials, or operations are not shown or described in detail to avoid obscuring various aspects of the embodiments. The reference to “an embodiment” in the context of this description indicates that a particular configuration, structure or characteristic described in relation to the embodiment is included in at least one embodiment. Therefore, phrases such as “in an embodiment”, possibly present in different places of this description do not necessarily refer to the same embodiment. Moreover, particular conformations, structures or characteristics can be combined in a suitable manner in one or more embodiments and/or associated with the embodiments in a different way from that illustrated here, for example, a characteristic here exemplified in relation to a figure may be applied to one or more embodiments exemplified in a different figure.

The references illustrated here are only for convenience and do not therefore delimit the field of protection or the scope of the embodiments.

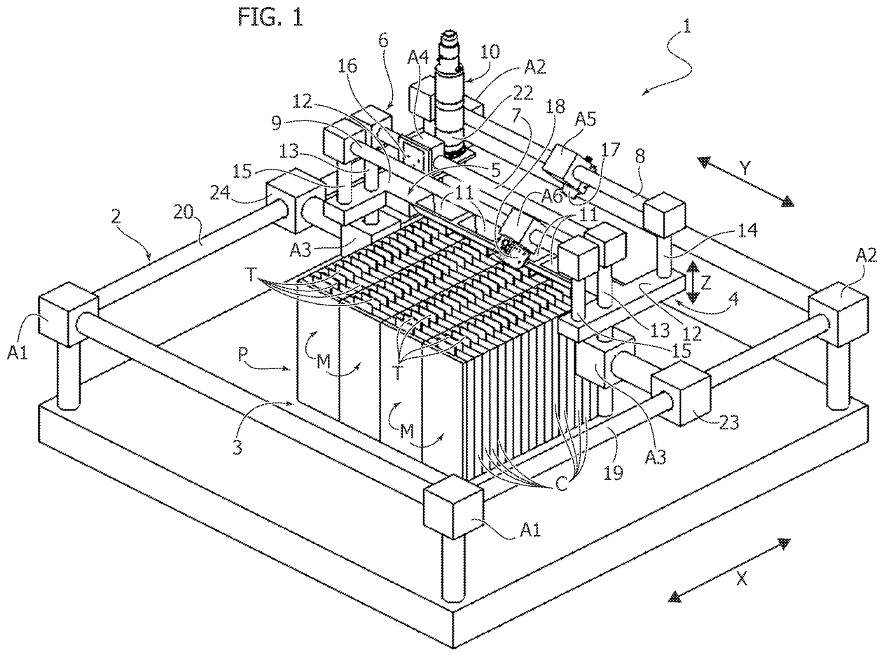

FIGS. 1-3 are schematic views illustrating an apparatus 1 for assembling battery cells C or battery modules M, according to an embodiment of the invention.

Some construction details of the apparatus are not illustrated in the attached drawings, since they can be made according to techniques widely known in the technical field of reference.

It should be noted that the apparatuses illustrated in the drawings are only embodiment examples, made in accordance with the present invention, since the invention is generally applicable to any apparatus for assembling battery cells or battery modules together, incorporating the unique characteristics stated in the attached claims.

The apparatus 1 according to the present invention is designed to assemble battery cells C or battery modules M together, comprising electrical terminals T that must be subjected to a welding operation. The electrical terminals T can be welded together and/or to respective electrical connecting elements.

The apparatus 1 can be used to assemble different types of battery cells and/or modules, for example, cells constituting battery packs for vehicles with a purely electric or hybrid propulsion system.

FIG. 4 is an enlarged scale view of an example of a battery pack P on which the apparatus 1 can operate. In accordance with a per se known technique, the battery pack P is defined by a plurality of modules M, each comprising a plurality of battery cells C (which in the illustrated example are of the “pouch” type, with a flattened and elongated body) arranged side-by-side in several rows, and having respective electrical terminals T. To make the battery pack P functional, the terminals T of the cells C of each row of side-by-side cells must be welded to a respective electrically conductive bar B (bus bar) associated with the cells C. As can be seen in FIG. 4, each conductor bar B, to be electrically connected to the terminals T of the respective row of cells C, is configured in the form of an elongated plate with parallel slots from which the terminals T protrude. According to the embodiment illustrated in the drawings, the electrical terminals T have a lamella shape vertically protruding from a respective slot of the respective bar B. Before proceeding with the welding of the terminals T to the electrically conductive bar B, the electrical terminals T must be bent, so as to achieve a bent configuration of the terminals T suitable for proceeding with the welding. Again with reference to the specific example of FIG. 4, a row of terminals T (the one furthest to the left in the figure) is illustrated in a pre-bending configuration, wherein the terminals T are vertically spaced and protruding through a series of slits obtained on the cells C, while a row of terminals T (the one furthest to the right in the figure) is shown in a bent configuration, wherein the terminals T are bent horizontally against the electrically conductive bar B, to which the terminals T must be welded.

In the attached drawings, the apparatus 1 is associated with a battery pack P having the characteristics indicated above. However, as already indicated above, the apparatus 1 can also be used to assemble other types of battery cells and modules not illustrated in the drawings.

In one or more embodiments of the invention, and as will be described in more detail below, the moving parts of the apparatus 1 that carry out the assembly of the cells C include:
an engagement and holding tool 4, designed to carry and maintain one or more battery cells C in a configuration and/or position suitable for being subjected to a welding operation, and
a welding head 10 arranged for welding the terminals T.

In accordance with a first relevant characteristic of the invention, the engagement and holding tool 4 can be moved along at least two axes, and the welding head 10 is carried on the tool 4, so as to provide a single movement system designed for carrying out both the preliminary step to the welding, wherein the cells C are kept in a configuration suitable for being subjected to a welding operation, and a welding step of the elements (i.e., the electrical terminals (T)) to be welded.

As will be further indicated in the following description, the engagement and holding tool 4 is controlled to keep the cells C in the aforesaid configuration during implementation of the welding of the elements (i.e., the electrical terminals (T)) to be welded.

In the following description, the embodiment illustrated in FIGS. 1-3 will now be described in detail.

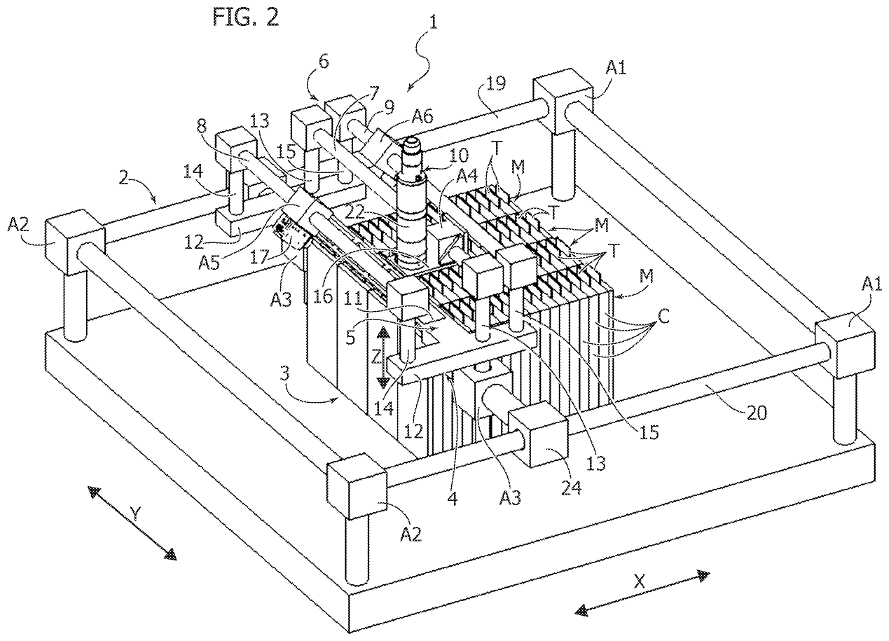

With reference to the perspective views of FIGS. 1, 2, the welding apparatus 1 comprises a supporting structure 2, defining at least one seat 3 on which to place a battery pack P to be assembled. The details relating to the seat 3 are not illustrated in the attached drawings since, as previously indicated, these details can be made according to any prior art.

According to this embodiment example, the tool 4, carrying the head 10, is movably mounted on the supporting structure 2 along two mutually orthogonal axes, in accordance with a general configuration substantially similar to that of a Cartesian robot, thus ensuring characteristics of high precision and repeatability.

The supporting structure 2 is illustrated in the attached drawings in an extremely schematic way, since it can be made according to any configuration known in the technical field of reference. The actuators that can be used to control the movements of the movable parts with respect to the supporting structure 2 are also illustrated in the attached drawings, which are extremely schematic and can be made in any known way.

According to the embodiment illustrated in FIGS. 1-3, the tool 4 assembly supported by the supporting structure 2 comprises a bending tool assembly 4, configured to simultaneously bend one or more elements (i.e., the electrical terminals (T), prior to welding. As indicated in greater detail in the following description, the bending tool assembly 4 includes a terminal-pressing bar 5 configured to simultaneously bend the electrical terminals T of a plurality of side-by-side cells C.

The terminal-pressing bar 5 is supported above the battery pack P on which the apparatus 1 must operate and is movable, with the whole assembly, in both a first horizontal direction X and in a vertical direction Z. In accordance with the example illustrated in FIGS. 1-3, the aforesaid first horizontal direction X is perpendicular to the longitudinal direction of the terminal-pressing bar 5.

The position of the assembly 4 is controlled along the aforesaid first horizontal direction X by respective actuators A1, A2, illustrated purely schematically in the drawings. The actuators A1, A2 may be electric or fluid actuators, made in any known way. According to the example of the figures, the bending tool assembly 4 can move according to the first horizontal direction X, by means of the sliding of a pair of carriages 23, 24, slidably mounted on respective end guides 19, 20. The opposite ends of the bending tool assembly 4 are connected to and supported by the carriages 23, 24. The components of the actuators A1, A2 are not illustrated in the attached drawings since, as said, these actuators can be made according to any known configuration, and since elimination of these details from the drawings makes the latter more readily and easily understood.

Reference A3 indicates additional actuators configured to perform the movement of the bending tool assembly 4 along the vertical direction Z. The actuators A3 can be made in such a way as to translate a rotary motion into a linear motion along the vertical direction Z according to any technique known per se.

According to the example illustrated in the drawings, two actuators A3 are arranged, respectively, in the vicinity of a respective carriage 23, 24, and are designed to be operated simultaneously in order to achieve the vertical movement of the assembly 4. As indicated in greater detail later in the description, the actuators A1, A2, A3 control the movement of the bending tool assembly 4, to achieve a horizontal movement along said first direction X, and a vertical movement along the direction Z, to complete the step of bending the terminals T, preliminary to the welding step.

As illustrated, in particular, in the perspective views of FIGS. 1, 2, the bending tool assembly 4 supports a frame 6 configured to move integrally with the bending tool assembly 4 along the first horizontal direction X and the vertical direction Z. The frame 6 is spaced in a raised and spaced apart position with respect to the terminal-pressing bar 5, and carries a welding head 10, configured to carry out the welding of the electrical terminals T. According to this embodiment, the welding head 10 is configured to carry out the welding, staying in a remote position with respect to the elements (i.e., the electrical terminals (T)) to be welded. Still in accordance with the embodiment illustrated in FIGS. 1-3, welding of the terminals T is carried out in such a way as to create a weld bead, which connects each terminal T to the respective electrically conductive bar B, subsequently to a step of bending the electrical terminals T achieved by means of the bending tool assembly 4.

In accordance with a characteristic of the invention, the welding head 10 is configured to move integrally with the tool 4.

With reference to the illustrated example, the welding head 10 is movably mounted on the frame 6 along a second horizontal direction Y, perpendicular to said first direction X. More particularly, the frame 6 includes a guiding bar 7 perpendicular to the first horizontal direction X, spaced in a raised and spaced apart position from the terminal-pressing bar 5 of the tool assembly 4.

The welding head 10 is movably mounted (along the direction Y) on the guiding bar 7 and is positioned to emit a welding beam passing through at least one opening 11 obtained on the terminal-pressing bar 5. It will, therefore, be appreciated that, by virtue of the fact that the welding head 10 is mounted on the frame 6, configured to move integrally with the bending tool assembly 4 along the first horizontal direction X and the vertical direction Z, the head 10 is thus movable according to three mutually orthogonal axes (X, Y, Z), according to a configuration substantially similar to that of a Cartesian robot.

The frame 6, configured to move integrally with the terminal-pressing bar 5 and carrying the welding head 10, is schematically illustrated in the attached drawings. In accordance with the illustrated schematic example, the frame 6 may comprise vertical portions 13, 14, 15, configured to support a respective end of the aforesaid horizontal guiding bar 7. The vertical portions 13, 14, 15, arranged on both sides of the terminal-pressing bar 5, are carried by a respective end portion 12 of the bending tool assembly 4. In the embodiment illustrated in the drawings, the aforesaid end portions 12 are bar-like end portions perpendicular to the terminal-pressing bar 5, wherein the extension of the bar-like end portions 12 is significantly less than the longitudinal extension of the terminal-pressing bar 5. Again with reference to the specific example illustrated in the drawings, the vertical portions of the frame 6 include a pair of vertical rods 13 connected, respectively, at one of their upper ends to a respective end of the horizontal guiding bar 7, carrying the head 10. The vertical rods 13 each comprise a lower portion supported by the bar-like end portions 12 of the assembly 4, and connected to one of said carriages 23, 24, to achieve the movement along the horizontal direction X.

As previously indicated, the actuators A3 for controlling the movement of the assembly 4, and of the frame 6 carrying the head 10, along the vertical direction Z, can be made according to a screw/nut mechanism operated by an electric motor, or in any other known way. According to a specific embodiment, the mechanism can also be implemented by means of a recirculating ball screw mechanism.

The actuators A1, A2, A3, operate the bending tool assembly 4, and the frame 6 carrying the head 10, so as to perform a horizontal movement along the first direction X and a vertical movement along the direction Z, to complete the step of bending the terminals T, prior to welding. Furthermore, as also indicated below, the bending tool assembly 4, in particular the terminal-pressing bar 5, is controlled to hold the terminals T in a bent position, during the welding step carried out by the head 10. The actuators A1, A2, A3 can be controlled by means of a control circuit, in such a way as to move the bending tool assembly 4 (and the head 10) along a predefined bending path, to bend the metal terminals T prior to welding.

As previously indicated, the welding head 10 is movably mounted on the aforesaid guiding bar 7 along the direction Y, and is positioned to emit a welding beam passing through at least one opening 11 obtained on the terminal-pressing bar 5.

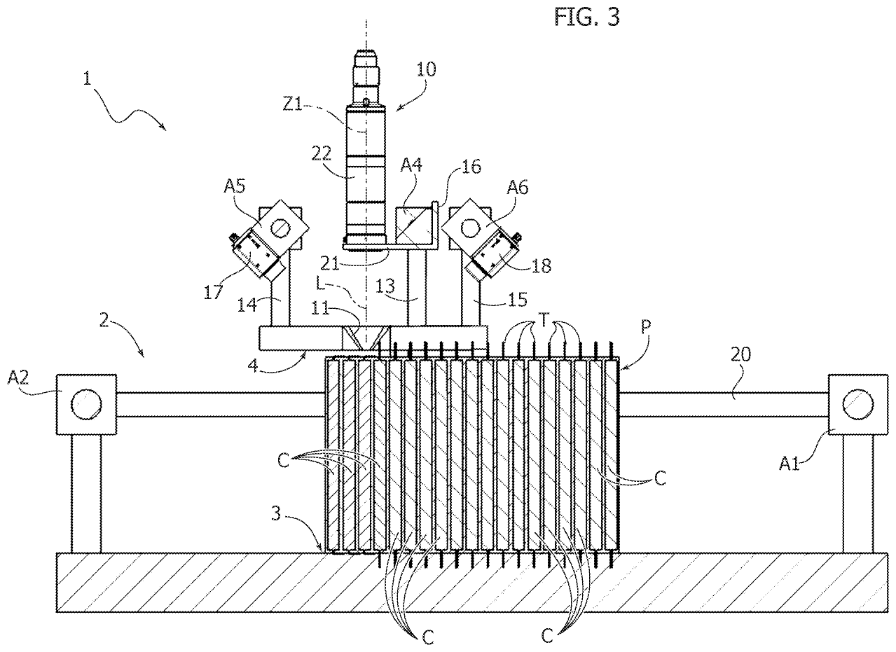

As illustrated—in particular—in the schematic cross-sectional view of FIG. 3, the welding head 10 is mounted on the guiding bar 7 by means of a supporting element 16 slidably mounted on the bar 7. Reference A4 indicates another actuator, designed to move the welding head 10 along the horizontal bar 7, and therefore, along the horizontal direction Y. With reference to the specific embodiment illustrated in the drawings, the supporting element 16 has an L-shaped conformation, defining a horizontal plane 21 on which the head 10 is supported.

In one or more embodiments, as well as in the one illustrated in the drawings, the welding head 10 is a laser focusing head of any known type, having a vertical axis Z1, and including a support structure 22 provided with a flange for coupling the supporting element 16 to the horizontal plane 21.

According to a per se known technique, the head 10 may receive a laser beam from a laser generator by means of an optical fiber. Consequently, the apparatus 1 may include a laser source (not illustrated in the drawings) associated with the welding head 10. The laser source and the welding head 10 may be controlled by means of a respective control circuit, also not illustrated in the attached drawings. The construction details of the welding head 10 and of the laser source are not illustrated here, since, as already indicated, they can be made in any known way and as these details do not fall, taken alone, within the scope of the present invention.

The welding head 10 is supported vertically by the supporting element 16, and is arranged spaced apart from the terminal-pressing bar 5 and from the terminals T to be welded, so as to be at a correct focusing distance with respect to the components to be welded, so that the welding beam (schematically illustrated by the dotted lines L in FIG. 3) effectively accomplish the welding of the terminals T. To carry out the welding of the terminals T, the head 10 is arranged so as to be vertically aligned with respect to the openings 11 of the terminal-pressing bar 5. In accordance with the embodiment illustrated in FIGS. 1-9, the openings 11 are arranged side-by-side along the longitudinal extension of the terminal-pressing bar 5. The openings 11 have a quadrangular shape and have, along a vertical direction Z, a tapered profile in the direction of the terminals T of the cells C (FIG. 3).

As previously indicated, the head 10 and the assembly 4 form a single movement system configured to carry out the assembly of the cells C. One or more electronic units (not illustrated in the drawings) may be provided for controlling the assembly 4 and the head 10. The actuators A1, A2, A3, A4 may be controlled by means of a control circuit in such a way as to move the bending tool assembly 4 (and the head 10) along a predefined bending path to bend the terminals T prior to welding, and to move the head 10 along a predefined welding path to weld the terminals T to an electrically conductive bar B associated with the cells C.

Optionally, one or more embodiments of the apparatus 1 may include auxiliary control characteristics, to control a vertical movement and/or an oscillation of the head 10, in addition to its movement that is integral with the assembly 4. Thanks to this characteristic, it is possible to vary the distance of the head 10 from the terminals T, making the apparatus even more flexible for different applications.

The welding head 10 can be made in accordance with any known welding device, with or without contact with the elements to be welded, such as, for example, a laser welding head. In one or more embodiments, the welding head 10 may be an electric spot welding device having an electrode that is movable along a vertical direction.

As previously indicated, the welding apparatus 1 illustrated in FIGS. 1-3 is configured to carry out, prior to the welding of the terminals T, a step of bending the terminals T to be welded, by means of the bending tool assembly 4.

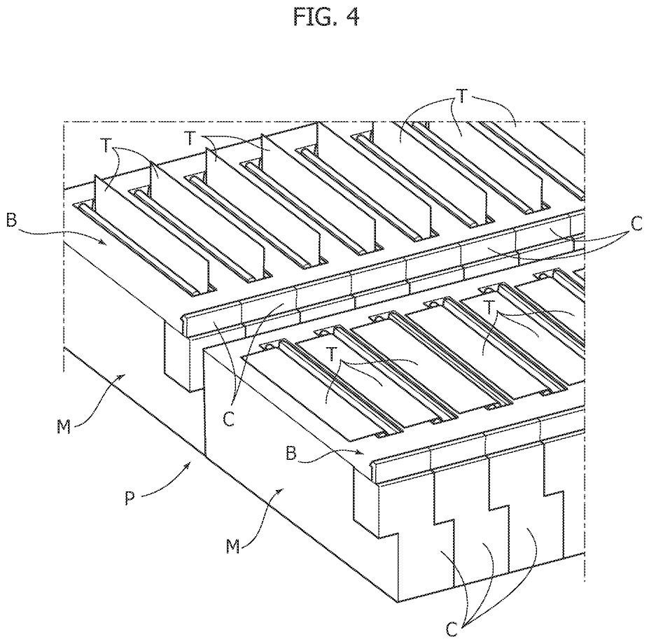

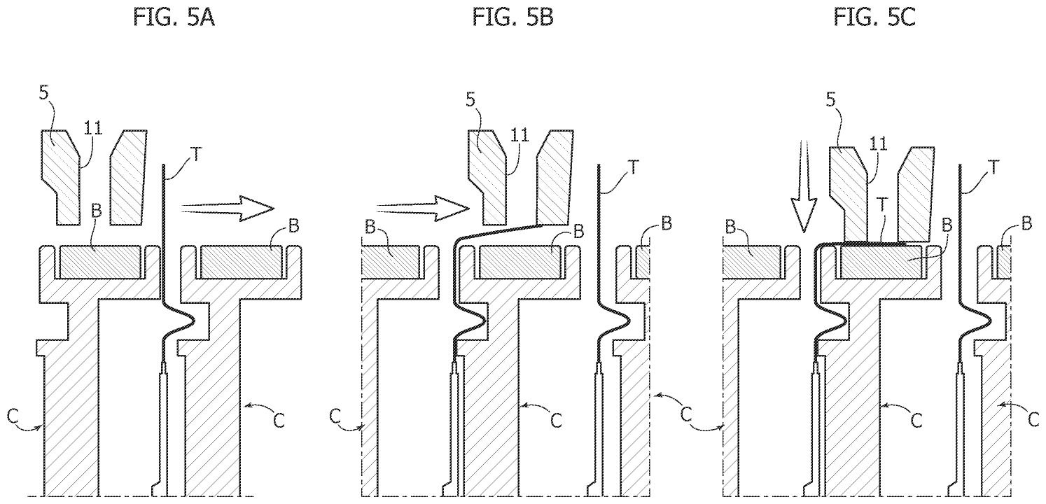

FIGS. 5A-5C are cross-sectioned schematic views that illustrate some steps of a method that can be carried out by means of the apparatus 1 illustrated in FIGS. 1-3, for assembling a battery pack P. The cross-sections of FIGS. 5A-5C are made according to a vertical plane, perpendicular to the horizontal direction Y. In FIG. 5A, a portion of the terminal-pressing bar 5 is arranged alongside a row of terminals T of a module M comprising a row of cells C. In FIG. 5B, the bending tool assembly 4 is controlled so as to carry out a horizontal movement along the first direction X, in such a way that the terminal-pressing bar 5 bends the terminals T. According to the example of the drawings, the terminals T, having a lamella shape vertically protruding from an upper wall of the battery pack P, are arranged in a bent configuration in the direction of the cells C and the electrically-conducting bars B. Subsequently, as illustrated in FIG. 5C, the terminal-pressing bar 5 is controlled to carry out a vertical movement along a direction Z, in such a way that the terminals T are arranged in a bent configuration, in contact with the electrically conductive bar B associated with the cells C. At this point, once the bending step is completed, the terminal-pressing bar 5 remains in a lowered position against the cells C and the bars B, and the welding head 10 is controlled to emit a welding beam through the opening 11, and weld the terminals T bent on the respective electrically conductive bar B. Thanks to these characteristics, the apparatus according to the invention ensures the simple and reliable control of a bending step of the terminals to be welded, prior to the welding of the terminals. Furthermore, in order to complete the welding of the terminals T, it is not necessary to prepare further components to keep the elements to be welded in position, before making the weld bead.

In accordance with a preferred characteristic of the invention, the apparatus 1 includes a system for automatically controlling the quality of the welding carried out by the welding head 10. Of course, this system can be associated with any type of apparatus 1 in accordance with the invention, without any limitation with respect to the embodiments illustrated in the drawings.

In one or more embodiments, this system for automatically controlling the quality is implemented by means of at least one thermal camera configured to control the quality of a weld bead in a welding area. The aforesaid thermal camera can be made in accordance with the technique described in the Italian patent application 102018000021022 by the same Applicant, which forms part of the state of the art pursuant to Art. 46(3) IPC. Of course, the quality control system may include one or more devices that are different from the aforesaid thermal camera, such as, for example, ultrasound, tomography, X-ray equipment, etc.

In the embodiment illustrated in the drawings, the frame 6 comprises a first and a second auxiliary horizontal guiding bar 8, 9, on which a first and a second thermal camera 17, 18 are slidably mounted, respectively. Each auxiliary horizontal guiding bar 8, 9 is spaced apart and parallel to the guiding bar 7 carrying the head 10, along a respective side of the bar 7. The thermal cameras 17, 18 are, therefore, able to move, similarly to the head 10, along the aforesaid second horizontal direction Y. Each auxiliary guiding bar 8, 9 is supported at the ends by a respective pair of vertical rods 14, 15. In a manner completely similar to that described above for the rods 13 of the horizontal bar 7 carrying the head 10, the rods 14,15 each comprise a lower portion supported by the bar-like end portions 12 of the bending tool assembly 4.

In accordance with that described in the Italian patent application 102018000021022, each thermal camera 17, 18, is configured to provide a thermal image that shows the welding area. During an operating condition of the head 10, the beam supplied by the welding head 10 moves along a welding path and heats the material of the components to be welded in a welding area, thus creating a weld bead by melting the materials of these components. The thermal cameras 17, 18 are configured to provide a two-dimensional image, wherein the value of each pixel identifies the temperature of a respective spot of the welding area. The thermal image is then processed by a processing circuit, such as, for example, a microprocessor programmed using software code. In particular, by carrying out welding, the pixels in the welding area will have higher values (i.e. higher temperatures), and the processing circuit can, therefore, detect an area in the thermal image that corresponds to the welding area. The processing circuit is configured to compare the value of each pixel of the thermal image with a reference threshold, select the pixels that have a value greater than a predetermined threshold, and approximate the area wherein the selected pixels are located with a rectangular or trapezoidal area. In various embodiments, this area is divided into a plurality of sub-areas and for each sub-area a respective temperature is determined as a function of the values of the pixels comprised in the respective sub-area. Thanks to these characteristics, the temperature trends are monitored, making it possible to estimate the quality of the welding performed.

As previously indicated, the thermal cameras 17, 18 are slidably mounted on a respective auxiliary horizontal guiding bar 8, 9. The position of the thermal cameras 17, 18 is controlled along the second horizontal direction Y by respective actuators A5, A6. The actuators A5, A6 may be electric or fluid actuators, made in any known way, similar to the actuator A4 that controls the head 10. Preferably the cameras 17, 18 are also configured to be able to rotate 360 degrees, in order to monitor a large welding area.

According to a characteristic of the invention, the cameras 17, 18 are controlled to slide along the respective horizontal auxiliary guiding bar 8, 9, following the movement of the welding head 10 on the bar 7, so as to analyze the quality of the weld carried out by the head 10, in real time, while the head 10 proceeds to weld the terminals T. As will be apparent from that described in detail below, the thermal cameras 17, 18 are controlled so as to monitor the quality of the welding, without including periods of inactivity of the quality control operating cycle, due to the movement of the thermal cameras, to follow the movement of the head 10.

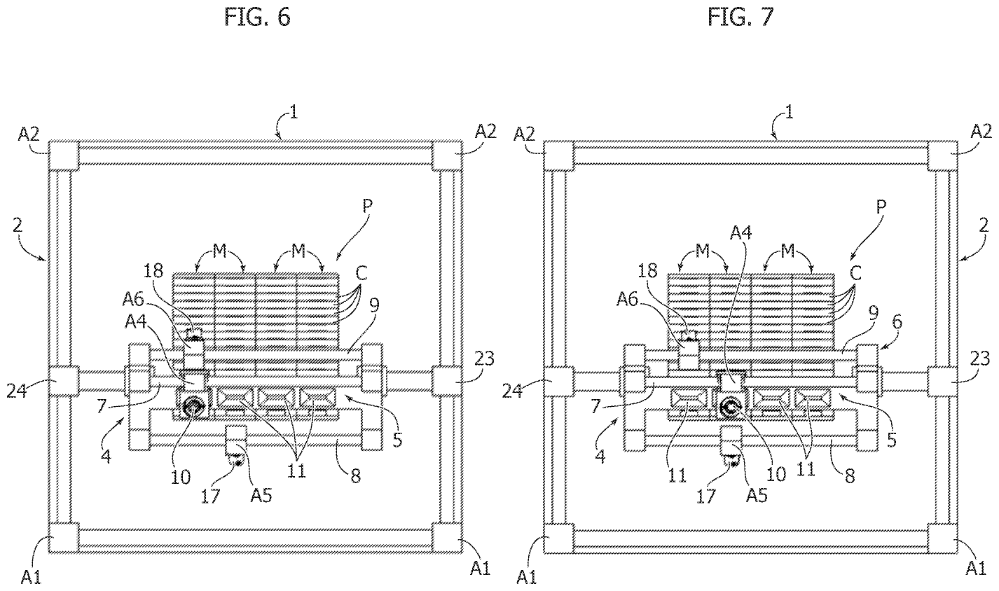

FIGS. 6-9 are schematic plan views illustrating the apparatus 1, and—in particular—the movement of the welding head 10 and of the cameras 17, 18 along the respective guiding bars 7, 8, 9, during a work cycle.

As illustrated in these figures, the thermal cameras 17, 18 are controlled so that one of said first and second cameras 17, 18 is always aligned with respect to a position wherein the head 10 is located for carrying out a welding, and the other of said first and second cameras 17, 18, is still arranged in a position further back, along the respective guiding bar 8, 9. This rearmost position is aligned with a previous position of the welding head 10, in such a way that the thermal camera 17, 18 in the rearmost position controls the cooling step of a weld bead after performing the welding.

In FIG. 6, the head 10 is in a first position along the horizontal guiding bar 7, to carry out a first welding step through a first opening 11 obtained on the terminal-pressing bar 5. One of the first or second cameras 17, 18 is arranged aligned (with reference to the horizontal direction Y) to the position of the head 10, so as to monitor the quality of the welding performed by the head 10. The other of said first and second camera 17, 18, is located in a more advanced position, along the horizontal direction Y, so as to “wait” for the welding head 10 when, once the first welding step has been completed, it will arrange itself in a more advanced position to carry out a second welding step through a second opening 11.

In FIG. 7, the welding head 10 has moved along the bar 7, to arrange itself in a second position suitable for carrying out a second welding step through a second opening 11.

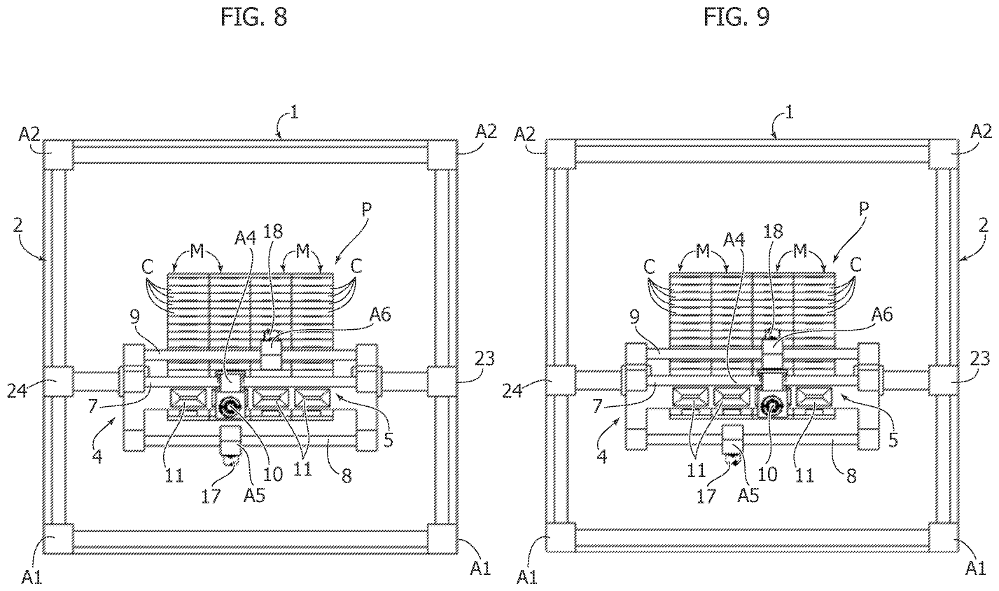

In FIG. 8, the second camera 18 has moved to a third position aligned, along the horizontal direction Y, with respect to a third position wherein the welding head 10 is arranged to carry out a further welding step. In this Figure, the first camera 17 monitors the welding step that the head 10 is carrying out through the second opening 11. In FIG. 9, the head 10 has moved from the second position to the third position and the second camera 18 is arranged in position, ready to monitor the welding that will be carried out in this third position.

In summary, according to the method described above, the cameras 17, 18 are controlled—by means of the respective actuators A5, A6—so that one of them is always ready to monitor the welding performed by the head 10 following the movement along bar 7.

Thanks to these characteristics, the apparatus 1 is designed to monitor the quality of a weld bead made with the welding head 10. Furthermore, the time required to carry out a complete welding cycle and to monitor its quality is extremely reduced, since the periods of inactivity of the operating cycle are eliminated, due to the movement of the cameras 17, 18, as a consequence of a movement of the head 10 for welding a row of terminals T.

In one or more embodiments, the apparatus comprises service systems for the electrical and/or fluid supply to said apparatus, and is provided with quick-coupling devices, of the “plug-in” type, for coupling with external electrical power and/or fluid supply systems. Also thanks to these characteristics, the commissioning/installation step of the apparatus 1 is extremely simple and quick.

Furthermore, according to a preferred characteristic of the invention, the apparatus 1—as a whole—is carried on a single palletizable equipped platform.

Thanks to all the characteristics indicated above, the welding apparatus 1 according to the invention is compact in size, has a simple and quick commissioning step, and is particularly suitable for being transported to different production sites, without having to resort to complicated transport and/or installation operations.

The apparatus 1 may also include a light-tight booth (not shown in the drawings), which encloses the frame 6 carrying the head 10, in such a way that the apparatus 1 includes all the components necessary for its operation “on board”, without having to resort to the assembly of additional components before being operational.

Of course, the construction details of the previously described embodiments may vary widely. This applies as much to the actuators A1, A2, A3, A4, A5, A6 as to the conformation of the terminal-pressing bar 5, the supporting frame 6, the welding head 10, as well as the thermal cameras 17, 18.

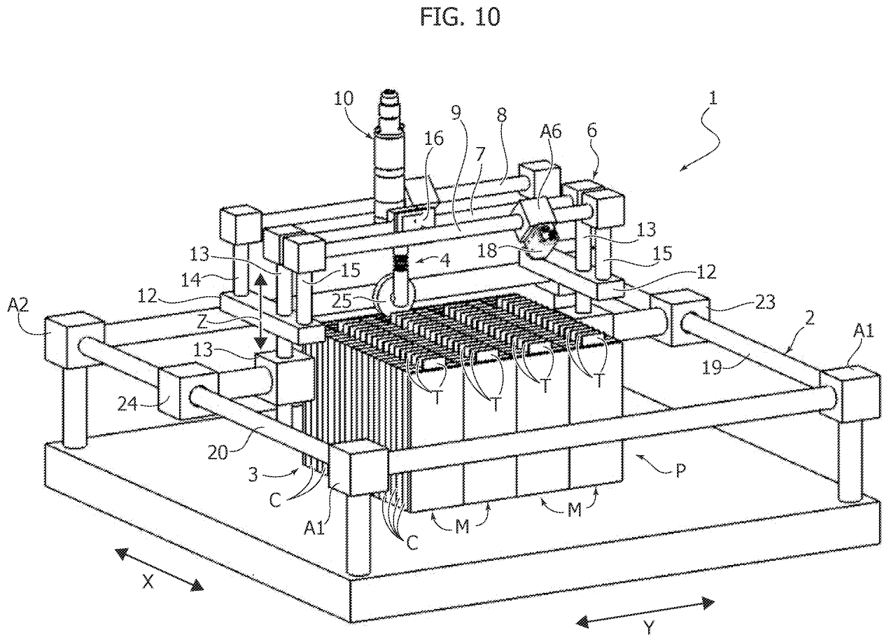

FIG. 10 illustrates another embodiment of the apparatus 1 according to the invention, wherein the engagement and holding tool 4 is a roller tool configured to carry and maintain the elements to be welded in a configuration suitable for implementing the welding. The tool, therefore, comprises a roller body 25, carried by an operating arm, configured to apply pressure on the elements to be welded. In the example shown, the operating arm extends along a vertical direction and is supported by the supporting element 16 carrying the head 10. The roller tool is configured in such a way that the head 10 may operate to weld the elements to be welded, while the tool maintains the terminals T in the aforesaid configuration suitable for carrying out the welding. Of course, the apparatus 1 illustrated in FIG. 10 is only another embodiment example of an apparatus made in accordance with the invention, as specified in the attached claims.

In accordance with another preferred characteristic of the invention, the apparatus 1 is able to be reconfigured automatically according to requirements, without the aid of an operator, to adapt to different types of batteries, for example, following reading of a QR code placed on the battery pack or on the bending tool assembly. For example, a reconfiguration of the program for controlling the movements of the tool assembly and the welding head may be envisaged. Furthermore, it is possible to provide a tool store with different terminal-pressing bars configured and arranged to operate on battery packs having different configurations and/or dimensions. In this case, the tool assembly 4 is connected to its supporting structure 2 by means of quick-coupling devices that allow automatic tool change.

As is clear from the above description, the welding apparatus according to the invention, therefore, has a number of undoubted advantages. In particular:
the apparatus according to the invention ensures a high welding quality, and the simple and reliable control of a step preliminary to the welding, wherein the elements to be welded are brought into a configuration and/or position suitable for carrying out the welding;
the apparatus according to the invention allows simultaneously bending of a row of terminals of a plurality of side-by-side cells, prior to the welding of the terminals;
the apparatus according to the invention is compact in size and has a simple and quick commissioning/installation step, and is also easily transportable to different production sites;
the apparatus according to the invention is easily and quickly adaptable to different applications, thus presenting a high flexibility of use; and
the apparatus according to the invention allows monitoring the quality of a weld bead made with a welding head that is part of the apparatus, also controlling the cooling step of each weld bead, without thereby inducing delays in the cycle time of the apparatus.

Of course, without prejudice to the principle of the invention, the details of construction and the embodiments may vary widely with respect to those described and illustrated purely by way of example, without departing from the scope of the present invention, as defined by the attached claims.

1. An apparatus for assembling battery cells or battery modules, wherein said battery cells or battery modules each comprise electrical terminals, which must be subjected to a welding operation, said apparatus comprising:
a tool for engaging and holding the battery cells or battery modules to be welded, the tool can be moved along at least two axes for carrying and maintaining one or more of the battery cells or the battery modules in at least one of a configuration or position suitable for welding the electrical terminals of said battery cells or the battery modules to at least one of respective electrical connecting elements or welding said electrical terminals to each other;
a welding head carried by said tool and arranged to perform welding operations on the electrical terminals to be welded,
wherein said tool and said welding head are controlled in such a way that the tool carries said battery cells or said battery modules into said at least one of the configuration or position suitable for performing the welding, and said tool maintains said battery cells or said battery modules in said at least one of the configuration and/or position during execution of the welding,
said tool being configured in such a way that the welding head can operate to perform the welding while the tool (4) maintains said battery cells (C) or battery modules (M) in said configuration and/or position suitable for welding.

2. The apparatus of claim 1, characterized in that said welding head carried by said tool is configured to carry out the welding while remaining in a remote position with respect to the electrical terminals to be welded.

3. The apparatus according to claim 1, characterized in that said welding head is configured to be movable integrally with said tool along said at least two axes, and said welding head is configured to at least one of move or oscillate along at least a third axis.

4. The apparatus according to claim 1, characterized in that said tool for engaging and holding the battery cells or the battery modules to be welded further comprises a bending tool, configured to simultaneously bend one or more of the electrical terminals, preliminarily to execution of the welding.

5. The apparatus according to claim 4, characterized in that said bending tool comprises a terminal-pressing bar configured to simultaneously bend the electrical terminals of a plurality of the battery cells located side-by-side, before the execution of the welding of the electrical terminals.

6. The apparatus according to claim 5, characterized in that said welding head is positioned so as to emit a welding beam passing through at least one opening defined by said terminal-pressing bar, in such a way that the welding head is configured to weld said electrical terminals, after the bending of the electrical terminals by said terminal-pressing bar, while the terminal-pressing bar holds the electrical terminals in a welding position.

7. The apparatus according to claim 6, characterized in that the terminal-pressing bar carries a guiding bar, oriented perpendicular to a first horizontal direction, the guiding bar arranged in a raised position and spaced apart from said terminal-pressing bar, said welding head being movably mounted on said guiding bar along a second horizontal direction.

8. The apparatus according to claim 7 wherein the bending tool further comprises a frame supporting said guiding bar, wherein the frame is connected to the bending tool so as to be movable integrally with the bending tool, along said first horizontal direction and along a vertical direction.

9. The apparatus according to claim 1, further comprising a system for automatically controlling a quality of the welding carried out by the welding head.

10. The apparatus according to claim 9, characterized in that said automatic control system comprises at least one thermal camera configured to check the quality of a weld bead in a welding area.

11. The apparatus according to claim 10, characterized in that said at least one thermal camera is configured to provide an image wherein a value of each pixel identifies a temperature of a respective spot of the welding area, so as to estimate the quality of the welding carried out.

12. The apparatus according to claim 10, the wherein the at least one thermal camera comprises a first thermal camera and a second thermal camera and the tool further comprises a frame comprising two auxiliary guiding bars oriented parallel and spaced apart from each other, on which theft first and theft second thermal camera are, respectively, slidably mounted.

13. The apparatus according to claim 12, characterized in that said first and second thermal cameras are controllable to slide along the respective auxiliary guiding bar, following the movement of the welding head on a guiding bar so as to analyze the quality of the welding carried out by the welding head, in real time, while the welding head carries out welding of the electrical terminals, and in that the first and second thermal cameras are controllable so that one of said first or second thermal camera is always aligned with respect to a position wherein the welding head is located for implementing the welding, and the other of said first or second thermal camera is still located in a position that is upstream, along the respective auxiliary guiding bar, in alignment with a previous position of the welding head, in such a way that the thermal camera in the upstream position controls a cooling step of the weld bead after the welding has been carried out.

14. The apparatus according to claim 1, further comprising a service system for at least one of an electrical or fluid supply to said apparatus, said apparatus is carried and positioned above a single equipped palletized platform, and the apparatus further comprising quick coupling devices configured for coupling with the at least one electrical or fluid supply.

15. A method for assembling at least one of battery cells or battery modules together, wherein said battery cells or battery modules each comprise electrical terminals, which must be subjected to a welding operation, said method comprising the following steps:
providing an apparatus according to claim 1;
controlling said tool for engaging and holding the battery cells or the battery modules to be welded, along said at least two axes, in order to carry and maintain one or more of the battery cells or the battery modules in at least one of a configuration and/or position suitable for welding the electrical terminals of said battery cells or said battery modules to respective of at least one of electrical connecting elements or said electrical terminals to each other; and
welding said electrical terminals by said welding head carried by said tool.

16. A method for checking the quality of a welding carried out by an apparatus according to claim 1 for assembling at least one of battery cells or battery modules, wherein said battery cells or battery modules each comprise electrical terminals, which must be subjected to a welding operation, said method comprising the following steps:
providing an apparatus including an automatic control system for checking a quality of the welding carried out by the welding head, and
controlling said automatic control system for automatically checking the quality of the welding, so as to analyze the quality of the welding carried out by the head, in real time, while the welding head proceeds welding the electrical terminals.

17. The method according to claim 16, wherein the automatic control system for checking the quality of the welding comprises a first and a second thermal camera configured to provide an image, wherein a value of each pixel identifies a temperature of a respective spot of a welding area, so as to estimate the quality of the welding carried out, said method further comprising the following steps:
controlling one of said first or second thermal camera in such a way that it is always aligned with respect to a position wherein the head is located for implementing the welding; and
controlling the other of said first or second thermal camera in such a way that it is located in a position that is upstream and aligned with a previous position of the welding head, in such a way that the thermal camera in the upstream position controls a cooling step of a weld bead after performing the welding.

18. The apparatus of claim 1, wherein the tool is configured to apply a pressure on the electrical terminals to be welded during the execution of the welding.
